(19) United States
(12) Patent Application Publication
(10) Pub. No.: US 2012/0274811 A1
(43) Pub. Date: Nov. 1, 2012

(54) IMAGING DEVICES HAVING ARRAYS OF IMAGE SENSORS AND PRECISION OFFSET LENSES

(76) Inventor: Dmitry Bakin, San Jose, CA (US)

(21) Appl. No.: 13/187,237

(22) Filed: Jul. 20, 2011

Related U.S. Application Data
(60) Provisional application No. 61/480,289, filed on Apr. 28, 2011.

(51) Int. Cl. H04N 5/262; H04N 5/247

(52) U.S. Cl. 348/239; 348/264; 348/E05.024; 348/E05.048

(57) ABSTRACT

Electronic devices may include array cameras having lens arrays, an corresponding color filter arrays, and corresponding image sensor arrays. Lenses in lens arrays may be aligned with positions on associated image sensors other than the centers of the associated image sensors. Lens arrays may include one or more layers of lenses formed by compression molding of transparent materials such as plastic. Lens arrays may be mounted directly onto integrated circuit dies on which the image sensor arrays are formed. Color filter arrays may include one or more red filters, one or more green filters and one or more blue filters. Offsetting the centers of lenses with respect to the centers of associated image sensors may allow capture of spatially offset single-color images by the image sensors. Spatially offset single-color images may be combined into super-resolution images using the processing circuitry.

This application claims the benefit of provisional patent application No. 61/480,289, filed Apr. 28, 2011, which is hereby incorporated by reference herein in its entirety.

### BACKGROUND

This relates generally to imaging devices, and more particularly, to imaging devices with multiple lenses and image sensors.

Image sensors are commonly used in electronic devices such as cellular telephones, cameras, and computers to capture images. In a typical arrangement, an electronic device is provided with a single image sensor having pixels for collecting image data and a single corresponding lens. Some electronic devices use arrays of image sensors and corresponding lenses to gather image data. This type of system, which is sometimes referred to as an array camera, may be used to extend depth of focus or capture depth information from a scene. Array cameras may also be used to improve image processing and information gathering processes such as gesture control, image segmentation or other image processing operations.

In a conventional array camera, image sensors are aligned with the centers of individual corresponding lenses. In array cameras in which each image sensor is associated with an individual lens, alignment of each image sensor with its corresponding lens is limited due to mechanical mounting tolerances. For this reason, each lens is typically aligned within a few tens of pixels of the center of a corresponding image sensor.

It would therefore be desirable to be able to provide improved imaging devices with array cameras having sub-pixel lens alignment precision.

### BRIEF DESCRIPTION OF THE DRAWINGS

FIG. 1 is a diagram of an illustrative electronic device in accordance with an embodiment of the present invention.

FIG. 2 is a diagram of an illustrative image sensor pixel in accordance with an embodiment of the present invention.

FIG. 3 is a diagram of a conventional array camera in which the lenses are aligned with the centers of corresponding image sensors.

FIG. 4 is a top view of an illustrative camera module having an array of lenses with precision offsets with respect to corresponding image sensors in accordance with an embodiment of the present invention.

FIG. 5 is a cross-sectional side view of an illustrative camera module having an array of lenses with precision offsets with respect to corresponding image sensors in accordance with an embodiment of the present invention.

FIG. 6 is an illustrative diagram of the required resolution of an individual lens for super-resolution imaging in accordance with an embodiment of the present invention.

FIG. 7 is an illustrative diagram showing how single-color images from multiple image sensors may be combined to form a super-resolution image in accordance with an embodiment of the present invention.

FIG. 8 is a flow chart of illustrative steps that may be used in producing super-resolution images using a camera module of the type shown in FIG. 4 in accordance with an embodiment of the present invention.

### DETAILED DESCRIPTION

Digital camera modules are widely used in electronic devices such as digital cameras, computers, cellular telephones, or other electronic devices. These electronic devices may include image sensors that gather incoming light to capture an image. The image sensors may include arrays of image pixels. The pixels in the image sensors may include photosensitive elements such as photodiodes that convert the incoming light into digital data. Image sensors may have any number of pixels (e.g., hundreds or thousands or more). A typical image sensor may, for example, have hundreds of thousands or millions of pixels (e.g., megapixels).

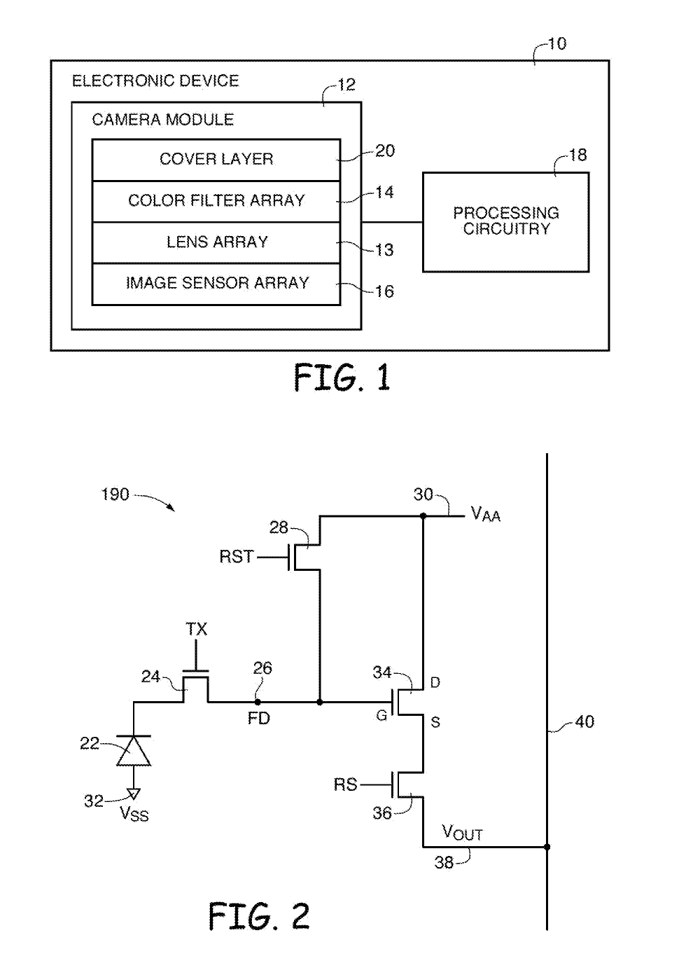

FIG. 1 is a diagram of an illustrative electronic device that uses an image sensor to capture images. Electronic device 10 of FIG. 1 may be a portable electronic device such as a camera, a cellular telephone, a video camera, or other imaging device that captures digital image data. Camera module 12 may be used to convert incoming light into digital image data. Camera module 12 may include a cover layer such as cover layer 20, an array of lenses such as lens array 13, a corresponding array of color filters such as color filter array 14, and a corresponding array of image sensors such as image sensor array 16. Lens array 13, color filter array 14, cover layer 20, and image sensor array 16 may be mounted in a common package and may provide image data to processing circuitry 18. Processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18. Processed image data may, if desired, be provided to external equipment (e.g., a computer or other device) using wired and/or wireless communications paths coupled to processing circuitry 18.

There may be any suitable number of lenses in lens array 13, any suitable number of color filters in color filter array 14, and any suitable number of image sensors in image sensor array 16. Lens array 13 may, as an example, include N*M lenses arranged in an N×M two-dimensional array. The values of N and M may be equal to or greater than one, may be equal to or greater than two, may exceed 10, or may have any other suitable values. The lenses in lens array 13 may include one or more lenses associated with each image sensor in image sensor array 16. Lenses in lens array 13 may be formed from one or more layers of lenses (i.e., lens array 13 may include one or more layers, each layer including an array of lenses). Each lens array layer in lens array 13 may be formed from individual lenses mounted in an a mounting structure or may be formed from an array of lenses formed on a single lens structure such as a plastic, glass, silicon or other structure on which multiple lenses may be formed. Lenses in lens array 13 may be formed using compression molding, transfer molding, injection molding, or other suitable methods for forming layers molded lens structures. Lenses in lens array 13 may be formed from a single material (e.g., plastic) or may be formed from multiple materials (i.e., one layer of lenses may be formed from one type of polymer material and another layer of lenses may be formed from another, different type of polymer material.)

Cover layer 20 may be formed from glass and may sometimes be referred to as cover glass. Cover layer 20 may also be formed from other transparent materials such as plastic. Color filter array 14 may be formed under cover layer 20 (i.e., between cover layer 20 and lens array 13). Color filter array 14 may include one or more color filters. Color filter array 14 may be formed separately from cover layer 20 or may be formed as an integral part of cover layer 20. Each color filter in color filter array 14 may be associated with a corresponding image sensor in image sensor array 16 and a corresponding lens in lens array 13.

Image sensor array 16 may contain a corresponding N×M two-dimensional array of individual image sensors. The image sensors may be formed on one or more separate semiconductor substrates and may contain numerous image sensor pixels. Complementary metal-oxide-semiconductor (CMOS) technology or other image sensor integrated circuit technologies may be used in forming image sensor pixels for image sensors in image sensor array 16. Some of the pixels in the image sensors of image sensor array 16 may be actively used for gathering light. Other pixels may be inactive, may be covered using array separating structures, or may be omitted from the array during fabrication. In arrays in which fabricated pixels are to remain inactive, the inactive pixels may be covered with metal or other opaque materials, may be depowered, or may otherwise be inactivated. There may be any suitable number of pixels fabricated in each image sensor of image sensor array 16 (e.g., tens, hundreds, thousands, millions, etc.). The number of active pixels in each image sensor of image sensor array 16 may be tens, hundreds, thousands, or more. With one suitable arrangement, which is sometimes described herein as an example, the image sensors are formed on a common semiconductor substrate (e.g., a common silicon image sensor integrated circuit die). Each image sensor may be identical or, if desired, some image sensors may be different (e.g., some image sensors may have different pixel sizes, shapes or sensitivity than other image sensors). For example, each image sensor may be formed from a portion of an 8 megapixel image sensor integrated circuit. Other types of image sensor may also be used for the image sensors if desired. For example, images sensors with VGA resolution, greater than VGA resolution or less than VGA resolution may be used, image sensor arrays in which the image sensors are not all identical may be used, etc.

Lenses in lens array 13 may be aligned with a position on an associated image sensor in image sensor array 16 that is not the center of the image sensor. Lenses in lens array 13 may be positioned to have an alignment shift in one or more directions away from the center of the associated image sensor in image sensor array 16. The shift in alignment between a lens in lens array 13 and the center of the associated image sensor in image sensor array 16 may be a fraction of the size of a pixel in the associated image sensor (e.g., one quarter, one half, three quarters, less than one quarter, more than one quarter but less than one half, more than one half but less than three quarters, more than three quarters but less than all of the size of the image pixel). Alternatively, the shift in alignment between a lens in lens array 13 and the center of the associated image sensor in image sensor array 16 may more than the size of a pixel in the associated image sensor. The use of a camera module with an array of lenses and an array of corresponding image sensors (i.e., an array camera) in which lenses in a lens array such as lens array 13 are laterally offset from the centers of associated image sensors in an image sensor array such as image sensor array 16 may allow capture and production of super-resolution images (i.e., images having pixels that are smaller than the pixels used to capture the image).

Each color filter in color filter array 14 may pass a single-color of light (e.g., green light, red light, blue light, infrared light, ultraviolet light, etc.), while blocking other colors of light. Some color filters in color filter array 14 may pass different colors of light than other color filters in color filter array 14. With one suitable arrangement, which is sometimes described herein as an example, color filter array 14 may include a two-by-two array of color filters in which one filter passes only blue light, two filters pass only green light, and one filter passes only red light. In comparison with conventional devices, an arrangement in which each image sensor has an associated color filter that passes only one color of light, color cross-talk (i.e., contamination of pixels configured to capture one color of light with other colors of light intended for nearby pixels) may also be reduced. This is because a single-color filter can be used for each image sensor in image sensor array 16 so that adjacent image pixels all receive the same color of light instead of using a conventional Bayer pattern or other multiple-color color filter array pattern over a single image sensor in which light of one color is often received by an image pixel that is immediately adjacent to another image pixel receiving another color of light. With a color filter array and single image sensor arrangement, there is no opportunity for color information to bleed from one color channel to another. As a result, signal-to-noise ratio and color fidelity may be improved. A single-color filter arrangement may also allow increased resolution as the pixels of a single image sensor are not subdivided into multiple colors (as in the case of a Bayer color filter array). The color filters that are used for the image sensor pixel arrays in the image sensors may, for example, be red filters (i.e., filters configured to pass only red light), blue filters (i.e., filters configured to pass only red light), and green filters (i.e., filters configured to pass only red light). Other filters such as infrared-blocking filters, filters that block visible light while passing infrared light, ultraviolet-light blocking filters, white color filters, dual-band IR cutoff filters (e.g., dual-band NIR image sensors having filters that allow visible light and a range of infrared light emitted by LED lights), etc. may also be used.

Processing circuitry 18 (e.g., processing circuitry integrated onto sensor array integrated circuit 16 and/or processing circuitry on one or more associated integrated circuits) can select which digital image data (i.e., image data from which image sensor) to use in constructing a final image for the user of device 10. For example, circuitry 18 may be used to blend image data from red, blue, and green sensors to produce full-color images. Full color images may include pixels that are smaller than the pixels of the individual image sensors. By combining image data from pixels of multiple image sensors having lenses that have lateral alignment offsets from the centers of the image sensors in which the offsets have sub-pixel magnitudes, these super-resolution color images may be produced. This is because knowledge of the magnitude and direction of the lateral offsets to sub-pixel precision allows reliable production super-resolution images without distortion of the scene being imaged in the combined images.

Processing circuitry 18 may also be used to select data from an image sensor having an associated infrared-passing filter when it is desired to produce infrared images, may be used to produce 3-dimensional (sometimes called stereo) images using data from two or more different sensors that have different vantage points when capturing a scene, may be used to produce increased DOF images using data from two or more image sensors, etc. In some modes of operation, all of the sensors on array 16 may be active (e.g., when capturing high-quality images). In other modes of operation (e.g., a low-power preview mode), only a subset of the image sensors may be used. Other sensors may be inactivated to conserve power (e.g., their positive power supply voltage terminals may be taken to a ground voltage or other suitable power-down voltage and their control circuits may be inactivated or bypassed).

Circuitry in an illustrative pixel of one of the image sensors in sensor array 16 is shown in FIG. 2. As shown in FIG. 2, pixel 190 includes a photosensitive element such as photodiode 22. A positive power supply voltage (e.g., voltage Vaa) may be supplied at positive power supply terminal 30. A ground power supply voltage (e.g., Vss) may be supplied at ground terminal 32. Incoming light is collected by photodiode 22 after passing through a color filter structure. Photodiode 22 converts the light to electrical charge.

Before an image is acquired, reset control signal RST may be asserted. This turns on reset transistor 28 and resets charge storage node 26 (also referred to as floating diffusion FD) to Vaa. The reset control signal RST may then be deasserted to turn off reset transistor 28. After the reset process is complete, transfer gate control signal TX may be asserted to turn on transfer transistor (transfer gate) 24. When transfer transistor 24 is turned on, the charge that has been generated by photodiode 22 in response to incoming light is transferred to charge storage node 26.

Charge storage node 26 may be implemented using a region of doped semiconductor (e.g., a doped silicon region formed in a silicon substrate by ion implantation, impurity diffusion, or other doping techniques). The doped semiconductor region (i.e., the floating diffusion FD) exhibits a capacitance that can be used to store the charge that has been transferred from photodiode 22. The signal associated with the stored charge on node 26 is conveyed to row select transistor 36 by source-follower transistor 34.

When it is desired to read out the value of the stored charge (i.e., the value of the stored charge that is represented by the signal at the source S of transistor 34), row select control signal RS can be asserted. When signal RS is asserted, transistor 36 turns on and a corresponding signal Vout that is representative of the magnitude of the charge on charge storage node 26 is produced on output path 38. In a typical configuration, there are numerous rows and columns of pixels such as pixel 190 in the image sensor pixel array of a given image sensor. A vertical conductive path such as path 40 can be associated with each column of pixels.

When signal RS is asserted in a given row, path 40 can be used to route signal Vout from that row to readout circuitry. If desired, other types of image pixel circuitry may be used to implement the image pixels of sensors 16-1, . . . 16-N. For example, each image sensor pixel 190 may be a three-transistor pixel, a pin-photodiode pixel with four transistors, a global shutter pixel, a time-of-flight pixel, etc. The circuitry of FIG. 2 is merely illustrative.

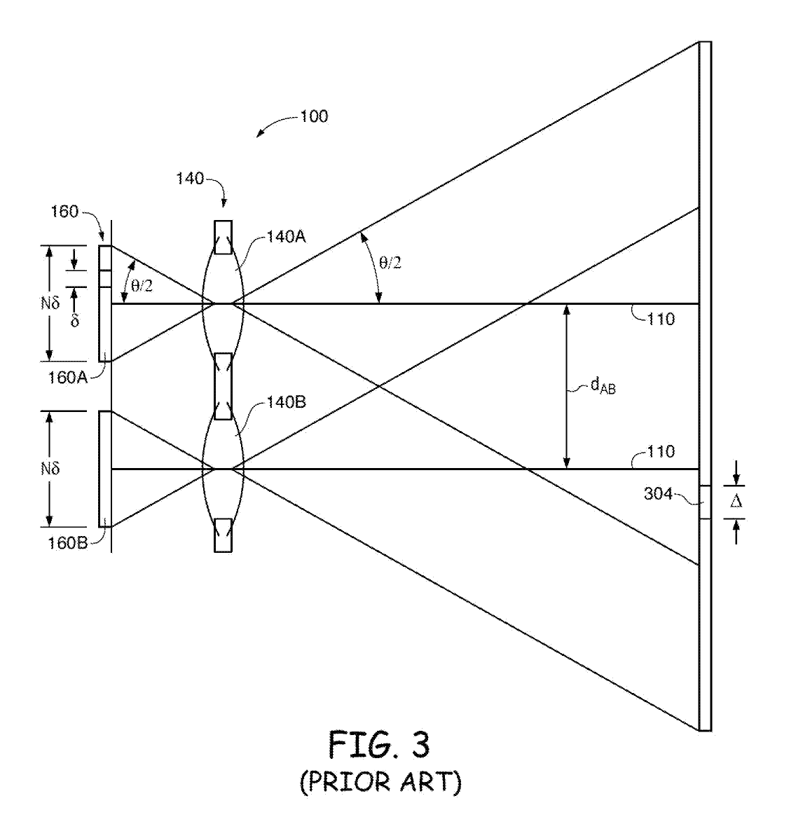

A diagram of a conventional array camera in which an array of identical lenses is aligned with the centers of corresponding image sensors is shown in FIG. 3. In the example of FIG. 3, camera 100 includes image sensor array 160, lens array 140 for capturing images. Lenses 140A and 140B focus light onto image sensors 160A and 160B respectively. The total horizontal field of view of a single lens is θ degrees. FIG. 3 shows width 6 of a single pixel in the image array and pixel image size Δ is the size of projected pixel image 304. N is the number of pixels across the width of the image array. Therefore, as indicated in FIG. 3, Nδ is equal to the width of each image array. As indicated by lines 110, lenses 140A and 140B are aligned with the centers of image sensors 160A and 160B respectively. Distance d_{AB} between the centers of image sensors 160A and 160B is equal to the distance between the centers of lenses 140A and 140B.

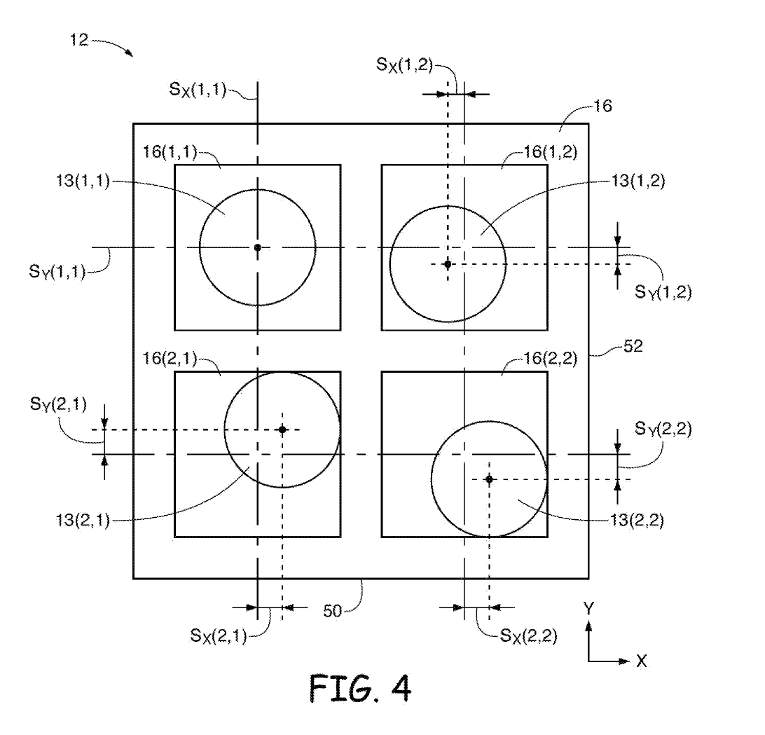

FIG. 4 is a top view of an illustrative camera module such as camera module 12 having an array of lenses such as lenses 13(1,1), 13(1,2), 13(2,1) and 13(2,2) that focus light onto image sensors such as image sensors 16(1,1), 16(1,2), 16(2,1) and 16(2,2) respectively. Lenses such as lenses 13(1,1), 13(1,2), 13(2,1) and 13(2,2) may form a part of lens array 13 of device 10 of FIG. 1. Image sensors such as image sensors 16(1,1), 16(1,2), 16(2,1) and 16(2,2) may form a part of image sensor array 16 of device 10 of FIG. 1. Image sensors may be formed from a single integrated circuit die. Lenses 13(1,1), 13(1,2), 13(2,1) and 13(2,2) may be formed on a single structure such as a plastic, glass, silicon or other structure on which multiple lenses may be formed. Lenses 13(1,1), 13(1,2), 13(2,1) and 13(2,2) may be formed using compression molding, transfer molding, injection molding, lithography, or other suitable methods for forming multiple lenses on a single structure. Lenses 13(1,1), 13(1,2), 13(2,1) and 13(2,2) may together form one of several layers of lenses that combine to focus light onto image sensors 16(1,1), 16(1,2), 16(2,1) and 16(2,2) respectively. Each layer of lenses may be formed from the same material (e.g., plastic) or different layers of lenses may be formed from different materials (i.e., one layer of lenses may be formed from one type of polymer material and another layer of lenses may be formed from another, different type of polymer material.)

In the example of FIG. 4, lenses 13(1,1), 13(1,2), 13(2,1) and 13(2,2) form a rectangular array having two rows and two columns of lenses and image sensors 16(1,1), 16(1,2), 16(2,1) and 16(2,2) for a corresponding rectangular array of image sensors having two rows and two columns. This is merely illustrative. Camera module may include more than four image sensors and more than four lenses, or may include less than four image sensors and less than four lenses. As shown in FIG. 3, camera module 12 may be configured such that the center of each lens (or layer of lenses) is laterally offset or shifted with respect to the center of a corresponding image sensor. The shift between the center of a lens (or lens stack or layer) and the center of a corresponding image sensor may be described by an x-direction shift Sx and a y-direction shift Sy where directions x and y are indicated in FIG. 4 (i.e, the x-direction may be aligned with an edge such as edge 50 of image sensor array 16 while the y-direction may be aligned with a perpendicular edge such as edge 52 of image sensor array 16). Shifts Sx and Sy may be used to characterize a magnitude and a direction of the lateral offset of a lens (or stack of lenses) from a corresponding image sensor.

In the example of FIG. 4, the center of lens 13(1,1) is substantially aligned with respect to the center of image sensor 16(1,1) (i.e., x-direction shift Sx(1,1) and y-direction shift Sy(1,1) are equal to zero). The center of lens 13(1,2) may be shifted with respect to the center of image sensor 16(1,2) by an amount (a magnitude) Sx(1,2) in a first direction (e.g., the x-direction) and by an amount (magnitude) Sy(1,2) in a perpendicular direction (e.g., the y-direction). The magnitudes of the lateral offset of lens 13(1,2) with respect to image sensors 16(1,2) as shown by Sx(1,2) and Sy(1,2) may be a fraction of the size of a pixel in the associated image sensor (e.g., one quarter, one half, three quarters, less than one quarter, more than one quarter but less than one half, more than one half but less than three quarters, more than three quarters but less than all of the size of the image pixel). Alternatively, the shift in alignment between a lens in lens array 13 and the center of the associated image sensor in image sensor array 16 may more than the size of a pixel in the associated image sensor. In one suitable arrangement, both shift Sx(1,2) and shift Sy(1,2) may be equal to half of the length of a lateral dimension of a pixel in an image sensor such as image sensor 16(1,1).

The center of lens 13(2,1) may be shifted with respect to the center of image sensor 16(2,1) by an amount Sx(2,1) in the x-direction and by an amount Sy(2,1) in the y-direction. Shifts Sx(2,1) and Sy(2,1) may be a fraction of the size of a pixel in the associated image sensor (e.g., one quarter, one half, three quarters, less than one quarter, more than one quarter but less than one half, more than one half but less than three quarters, more than three quarters but less than all of the size of the image pixel). Alternatively, the Sx(2,1) and Sy(2,1) may more than the size of a pixel in the associated image sensor. In one suitable arrangement, both shift Sx(2,1) and shift Sy(2,1) may be equal to half of the length of a lateral dimension of a pixel in an image sensor such as image sensor 16(1,1). Shifts Sx(2,1) and shift Sy(2,1) may be equal to shifts Sx(1,2) and shift Sy(1,2) respectively, may have opposite signs (i.e., indicate offsets in an opposite direction) to Sx(2,1) and shift Sy(2,1), or may have different sizes from shifts Sx(2,1) and shift Sy(2,1).

The center of lens 13(2,2) may be shifted with respect to the center of image sensor 16(2,2) by an amount Sx(2,2) in the x-direction and by an amount Sy(2,2) in the y-direction. Shifts Sx(2,2) and Sy(2,2) may be a fraction of the size of a pixel in the associated image sensor (e.g., one quarter, one half, three quarters, less than one quarter, more than one quarter but less than one half, more than one half but less than three quarters, more than three quarters but less than all of the size of the image pixel). Alternatively, the Sx(2,2) and Sy(2,2) may more than the size of a pixel in the associated image sensor. In one suitable arrangement, both shift Sx(2,2) and shift Sy(2,2) may be equal to half of the length of a lateral dimension of a pixel in an image sensor such as image sensor 16(1,1). Shifts Sx(2,2) and shift Sy(2,2) may be equal to shifts Sx(1,2) and shift Sy(1,2) respectively, may be equal to shifts Sx(2,1) and shift Sy(2,1) respectively, may have opposite signs (i.e., indicate offsets in an opposite direction) to Sx(1,2) and shift Sy(1,2), may have equal sizes but opposite signs to Sx(2,1) and shift Sy(2,1) or may have different sizes from shifts Sx(1,2), Sy(1,2), Sx(2,1) and Sy(2,1).

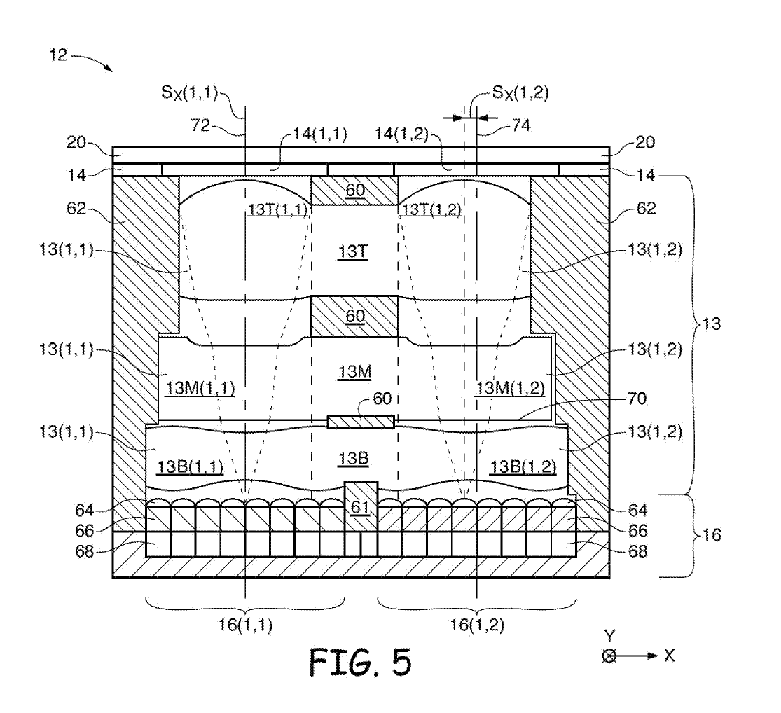

FIG. 5 is a cross-sectional side view of an illustrative camera module such as camera module 12 of FIGS. 1 and 4 that may be included in an electronic device such as device 10 of FIG. 1. As shown in FIG. 5, camera module 12 may include a cover layer such as cover layer 20, an array of lenses such as lens array 13, a corresponding array of color filters such as color filter array 14, and a corresponding array of image sensors such as image sensor array 16. Lens array 13, color filter array 14, cover layer 20, and image sensor array 16 may be mounted in a common package and may provide image data to processing circuitry 18 (see FIG. 1). As an example, lens array 13 may be mounted directly onto image sensor array 16 using housing structures such as housing structures 62. Image sensor array 16 may be formed on a common semiconductor substrate (e.g., a common silicon image sensor integrated circuit die) and lens array 13 may be mounted on the semiconductor substrate using housing structures 62.

There may be any suitable number of lenses in lens array 13, any suitable number of color filters in color filter array 14, and any suitable number of image sensors in image sensor array 16. Lens array 13 may, as an example, be formed from one or more layers of lenses. Lenses in layers of lenses in lens array 13 may be formed one or more layers of lenses such as top lens layer 13T, middle lens layer 13M and bottom lens layer 13B. Each lens array layer in lens array 13 may be formed from individual lenses mounted in an a mounting structure or may be formed from an array of lenses formed on a single structure such as a plastic, glass, silicon or other structure on which multiple lenses may be formed. Top lens layer 13T, middle lens layer 13M and bottom lens layer 13B may each be formed using compression molding, transfer molding, injection molding, lithography, or other suitable methods. Top lens layer 13T, middle lens layer 13M and bottom lens layer 13B may each be formed from the same material (e.g., plastic) or may each be formed from a different material (e.g., top lens layer 13T and middle lens layer 13M may be formed from one type of polymer material while bottom lens layer 13B is formed from a different type of polymer material, top lens layer 13T and bottom lens layer 13B may be formed from one type of polymer material while middle lens layer 13M is formed from a different type of polymer material, etc.) Alternatively, top lens layer 13T, middle lens layer 13M and bottom lens layer 13B may all be formed from the same material. Forming tope lens layer 13T, middle lens layer 13M and bottom lens layer 13B from the same material may increase the precision with which lens array 13 may be aligned with image sensor array 16. In conventional devices such as device 190 of FIG. 3, different materials are preferred in forming lenses 140 in order to control chromatic aberration associated with lenses 140. Camera module 12 of FIG. 5 may be provided with color filters such as color filters 14(1,1) and 14(1,2) that filter incoming light before it passes through lenses in lens array 13. Filtering incoming light before it passes through lens array 13 may reduce effects of chromatic aberration and allow top lens layer 13T, middle lens layer 13M and bottom lens layer 13B to be formed from the same material.

Middle lens layer 13M may have a bottom surface such as bottom surface 70 that is substantially planar (i.e., a flat bottom surface). Providing middle lens layer 13M with a flat bottom surface may simplify alignment of top, middle and bottom lens layers 13T, 13M, and 13B respectively with image sensors of image sensor array 16.

Top lens layer 13T may be mounted to cover layer 20 using housing structures such as housing structures 62 and spacer structuring such as spacer structures 60. Middle lens layer 13M may be mounted to top lens layer 13T and bottom lens layer 13B using housing structures such as housing structures 62 and spacer structuring such as spacer structures 60. Bottom lens layer 13B may be mounted to middle lens layer 13M using housing structures such as housing structures 62 and spacer structures such as spacer structures 60. Bottom lens layer 13B may be mounted to image sensor array 16 using housing structures such as housing structures 62 and spacer-buffer structures such as spacer-buffer structure 61. Spacer buffer structure 61 may also be used to separate one image sensor from another image sensor (e.g., to divide pixels 68 of image sensor 16(1,1) from the pixels 68 of image sensor 16(1,1)).

Color filter array 14 may be formed separately from cover layer 20 or may be formed as an integral part of cover layer 20. Each color filter in color filter array 14 may be associated with a corresponding image sensor in image sensor array 16 and a corresponding lens in lens array 13. For example, color filter 14(1,1) may filter light to be focused onto image sensor 16(1,1) by offset lens stack 13(1,1). Color filter 14(1,2) may filter light to be focuses onto image sensor 16(1,2) by offset lens stack 13(1,2), etc. Color filter array 14 may be formed under cover layer 20 (i.e., between cover layer 20 and lens array 13). Cover layer 20 may be formed from glass and may sometimes be referred to as cover glass. Cover layer 20 may also be formed from other transparent materials such as plastic.

Color filters such as color filters 14(1,1) and 14(1,2) in color filter array 14 may each pass a single-color of light (e.g., green light, red light, blue light, infrared light, ultraviolet light, etc.), while blocking other colors of light. Some color filters in color filter array 14 may pass different colors of light than other color filters in color filter array 14. As an example, color filter 14(1,1) may be a red color filter (i.e., a filter that passes red light and blocks other colors of light) while color filter 14(1,2) may be a green color filter (i.e., a filter that passes green light and blocks other colors of light.

Color filter array 14 may include a two-by-two array of color filters having a blue color filter, two green color filters and one red color filter. An arrangement in which each image sensor of image sensor array 16 receives light through a color filter that passes only one color of light may allow increased resolution as the pixels of a single image sensor are not subdivided into multiple colors (as in the case of a Bayer color filter array). Color filters such as color filters 14(1,1) and 14(1,2) may be red filters, blue filters, and green filters, infrared-blocking filters, filters that block visible light while passing infrared light, ultraviolet-light blocking filters, white color filters, dual-band IR cutoff filters (e.g., dual-band NIR image sensors having filters that allow visible light and a range of infrared light emitted by LED lights), etc.

Top lens layer 13T, middle lens layer 13M and bottom lens layer 13B may each include N*M lenses arranged in an N×M two-dimensional array. The values of N and M may be equal to or greater than one, may be equal to or greater than two, may exceed 10, or may have any other suitable values. In the example of FIG. 5, top lens layer 13T, middle lens layer 13M and bottom lens layer 13B each include one lens associated with one image sensor of image sensor array 16. As shown in FIG. 5, image sensor 16(1,1) of image sensor array 16 has an associated offset lens stack 13(1,1). Lens stack 13(1,1) includes lens 13T(1,1) of top lens layer 13T, lens 13M(1,1) of middle lens layer 13M, and bottom lens 13B(1,1) of bottom lens layer 13B. The lenses in lens array 13 may include one or more lenses associated with each image sensor in image sensor array 16.

Image sensor array 16 may contain a corresponding N×M two-dimensional array of individual image sensors. The image sensors may be formed on one or more separate semiconductor substrates and may contain numerous image sensor pixels. Complementary metal-oxide-semiconductor (CMOS) technology or other image sensor integrated circuit technologies may be used in forming image sensor pixels for image sensors in image sensor array 16. With one suitable arrangement, which is sometimes described herein as an example, the image sensors are formed on a common semiconductor substrate (e.g., a common silicon image sensor integrated circuit die). Image sensors such as image sensors 16(1,1) and 16(1,2) of image sensor array 16 may each include any number of image pixels 68. Image pixels 68 may include photosensitive elements such as photodiodes for converting light into electric charge. Image pixels 68 may include circuitry such as the circuitry of pixel 190 of FIG. 2 or may include other circuitry. Each image pixel 68 may include a microlens such as microlenses 64 for focusing light onto the image pixel. Microlenses 64 may be formed on the semiconductor substrate on which image pixels 68 are formed. Image sensors such as image sensors 16(1,1) and 16(1,2) of image sensor array 16 may each include an additional color filter such as color filters 66. Color filters 66 may be formed between microlenses 64 and image pixels 68 of image sensors such as image sensors 16(1,1) and 16(1,2). Color filters 66 may be configured to pass the same color of light to all pixels 68 of a given image sensor. As an example, color filter 66 of image sensor 16(1,1) may be configured to pass red light onto all pixels 68 of image sensor 16(1,1), color filter 66 of image sensor 16(1,2) may be configured to pass green light onto all pixels 68 of image sensor 16(1,2), etc. Color filters 66 of a given image sensor may be configured to pass the same color light as that passed by the color filter of color filter array 14 associated with that image sensor. As an example, color filter 66 of image sensor 16(1,1) may be configured to pass the same color of light as color filter 14(1,1), color filter 66 of image sensor 16(1,2) may be configured to pass the same color of light as color filter 14(1,2), etc. Alternatively, color filter 66 of a given image sensor may pass a different color of light than the color filter of color filter array 14 associated with that image sensor, may be configured to pass a narrower range of colors than the color filter of color filter array 14 associated with that image sensor, etc.

Image sensors such as image sensors 16(1,1) and 16(1,2) of image sensor array 16 may be formed from a portion of a larger image sensor integrated circuit (e.g., an 8 megapixel image sensor) and divided into multiple image sensors using spacer-buffer structures such as spacer-buffer structure 61.

As shown in FIG. 5, offset lens stacks such as lens stack 13(1,1) and 13(1,2) may focus light onto associated image sensors such as image sensors 16(1,1) and 16(1,2) respectively. Light that has passed through cover layer 20 and color filter 14(1,1) may be focused by top lens 13T(1,1), middle lens 13M(1,1) and bottom lens 13B(1,1) onto image sensor 16(1,1). Light that has passed through cover layer 20 and color filter 14(1,2) may be focused by top lens 13T(1,2), middle lens 13M(1,2) and bottom lens 13B(1,2) onto image sensor 16(1,2).

As shown in FIG. 5, lenses in lens array 13 may be aligned with a position on an associated image sensor in image sensor array 16 that is not the center of the image sensor. Lenses such as lens stacks 13(1,1) and 13(1,2) of lens array 13 may be positioned to have an alignment shift (i.e., a spatial offset) in one or more directions away from the center of associated image sensors 16(1,1) and 16(1,2) respectively. The shift in alignment between an offset lens stack in lens array 13 and the center of the associated image sensor in image sensor array 16 may be a fraction of the size of a pixel in the associated image sensor (e.g., one quarter, one half, three quarters, less than one quarter, more than one quarter but less than one half, more than one half but less than three quarters, more than three quarters but less than all of the size of the image pixel). Alternatively, the shift in alignment between a lens in lens array 13 and the center of the associated image sensor in image sensor array 16 may more than the size of a pixel in the associated image sensor. In the example of FIG. 5, the center of lens stack 13(1,1) is substantially aligned with respect to the center of image sensor 16(1,1) (i.e., x-direction shift Sx(1,1) is equal to zero) as indicated by line 72. The center of offset lens stack 13(1,2) may be shifted with respect to the center of image sensor 16(1,2) (indicated by dashed line 74) by an amount Sx(1,2) in the x-direction. The center of offset lens stacks 13(1,1) and 13(1,2) may also be shifted by amounts Sy(1,1) and Sy(1,2) in the y-direction respectively (see FIG. 4). Shifts Sx(1,2) and Sy(1,2) may be a fraction of the size of a pixel in the associated image sensor (e.g., one quarter, one half, three quarters, less than one quarter, more than one quarter but less than one half, more than one half but less than three quarters, more than three quarters but less than all of the size of the image pixel). Alternatively, the shift in alignment between a lens in lens array 13 and the center of the associated image sensor in image sensor array 16 may more than the size of a pixel in the associated image sensor. In one suitable arrangement, both shift Sx(1,2) and shift Sy(1,2) may be equal to half of the length of a lateral dimension of a pixel in an image sensor such as image sensor 16(1,1). Offset lens stacks such as lens stacks 13(1,1) and 13(1,2) may be configured so that images captured using image sensors such as image sensors 16(1,1) and 16(1,2) have a relative spatial offset. Color filters such as color filters 14(1,1) and 14(2,2) may, together with offset lens stacks 13(1,1) and 13(1,2) may be configured such that images captured using image sensors such as image sensors 16(1,1) and 16(1,2) are single-color, spatially-offset images that may be combined using processing circuitry 18 to form a super-resolution color image.

The centers of other lens stacks in lens array 13 may also be shifted with respect to the centers of associated image sensors. The use of a camera module with an array of lenses and an array of corresponding image sensors (i.e., an array camera) in which lens stacks in a lens array such as lens array 13 are offset from the centers of associated image sensors in an image sensor array such as image sensor array 16 may allow capture and production of super-resolution images (i.e., images having pixels that are smaller than the pixels used to capture the image).

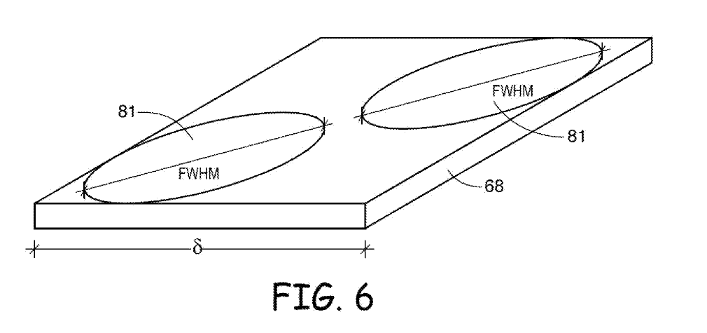

FIG. 6 is a perspective view of a representative image pixel such as image pixel 68 (see FIG. 5) showing the resolution of each lens stack in lens array 13. As shown in FIG. 6, a point of light that has been focused onto pixel 68 may have a footprint (i.e., a two dimensional projection of a point-spread-function) such as footprints 81. Lens stacks in lens array 13 may produce footprints having a full-width-half-maximum width FWHM. Pixel 68 may have a maximum lateral dimension δ. In one preferred embodiment that is sometimes discussed herein as an example, width FWHM may be less than the maximum diagonal dimension of pixel 68. Pixel 68 may have a shape that is square. In the example of a square image pixel, width FWHM may be less than (δ*√2). Providing lens stacks having point spread functions with widths FWHM less than the maximum diagonal dimension of image pixels in associated image sensors may allow images captured using multiple image sensors to be combined to form super-resolution images.

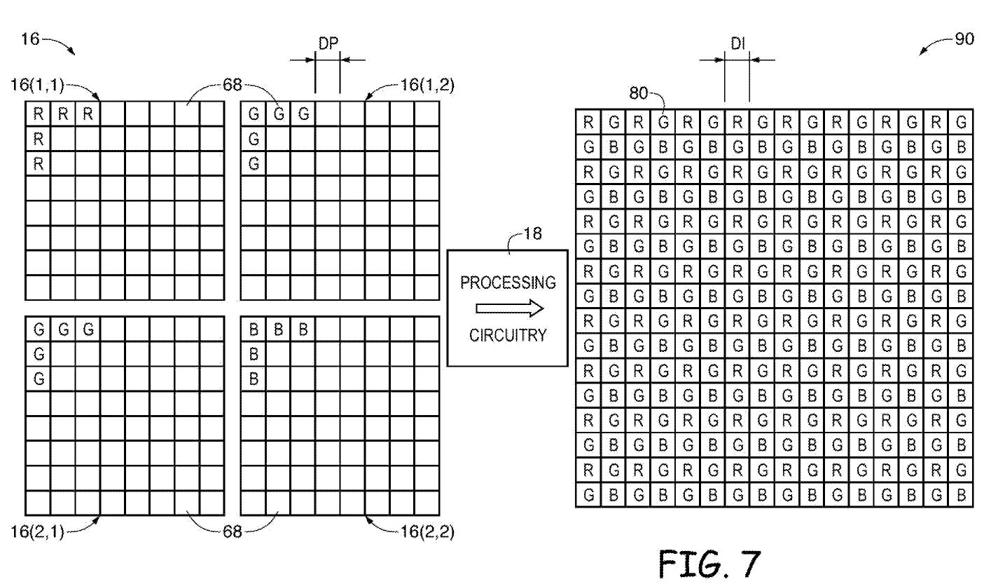

FIG. 7 is an illustrative diagram showing how images captured using multiple individual image sensors such as image sensors 16 of camera module 12 of FIG. 4 may be combined to form super-resolution images (i.e., images having pixel sizes smaller than the pixels of the images captured by the individual image sensors). As shown in FIG. 7, image sensor array 16 may include four individual image sensors such as image sensors 16(1,1), 16(1,2), 16(2,1), and 16(2,2). Image pixels 68 of image sensor 16(1,1) may be red image pixels (i.e., pixels that receive light through red color filters such as color filters 66 and 14(1,1) of FIG. 4). Image pixels 68 of image sensor 16(1,2) may be green image pixels (i.e., pixels that receive light through red color filters such as color filters 66 and 14(1,2) of FIG. 4). Image pixels 68 of image sensor 16(2,1) may be green image pixels and image pixels 68 of image sensor 16(2,2) may be blue image pixels. Image sensors 16(1,1), 16(1,2), 16(2,1), and 16(2,2) may capture red, green, green, and blue images, respectively, of a real world scene. Red, green and blue images captured by image sensors 16(1,1), 16(1,2), 16(2,1), and 16(2,2) may be offset from each other due to offsets such as offsets Sx(1,1), Sy(1,1), Sx(1,2), Sy(1,2), Sx(2,1), Sy(2,1), Sx(2,2), and Sy(2,2) of lens stacks 13(1,1), 13(1,2), 13(2,1) and 13(2,2) of lens array 13 respectively (see FIG. 4). Red, green and blue images captured by image sensors 16(1,1), 16(1,2), 16(2,1), and 16(2,2) may each have pixel sizes DP as shown in FIG. 7. By positioning lens stacks 13(1,1), 13(1,2), 13(2,1) and 13(2,2) of lens array 13 having offsets Sx(1,1), Sy(1,1), Sx(1,2), Sy(1,2), Sx(2,1), Sy(2,1), Sx(2,2), and Sy(2,2) with respect to image sensors 16(1,1), 16(1,2), 16(2,1), and 16(2,2), red, green and blue color images captured by image sensors 16(1,1), 16(1,2), 16(2,1), and 16(2,2) may be combined using processing circuitry 18 to form a super-resolution image such as super-resolution image 90. In the example of FIG. 7, super-resolution image 90 has image pixels 80 having pixel sizes DI that are smaller than pixel sizes DP of single-color images captured using image sensors 16(1,1), 16(1,2), 16(2,1), and 16(2,2). Super-resolution image 90 may be formed by combining single-color images captured by image sensors 16(1,1), 16(1,2), 16(2,1), and 16(2,2) in a color pattern in which some rows of image pixels contain alternating red and green image pixels and other rows of image pixels contain alternating green and blue image pixels (i.e., in a reconstructed Bayer color pattern).

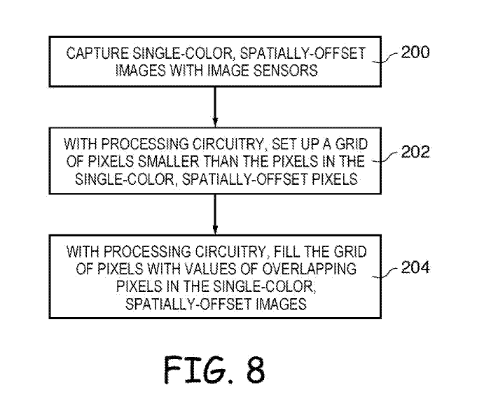

FIG. 8 is a flow chart of illustrative steps that may be used in producing super-resolution images such as super-resolution image 90 of FIG. 7 using an electronic device such as device 10 of FIG. 1. As shown in FIG. 8, at step 200, single-color, spatially-offset images may be captured using the image sensors of an array camera of the type shown in FIGS. 4 and 5.

At step 202, processing circuitry such as processing circuitry 18 of FIG. 1 may be used to set up a grid of pixels having pixel sizes that are smaller than the size of the pixels in the single-color, spatially-offset images.

At step 204, processing circuitry 18 may be used to combine the single-color, spatially-offset images into a super-resolution color image such as super-resolution color image 90 by filling the grid of pixels with the values of the overlapping pixels in the single-color, spatially-offset images (i.e., assigning each pixel in the grid of pixels a value corresponding to an associated value of an overlapping pixel in a selected one of the single-color, spatially-offset images). Offsets Sx(1,1), Sy(1,1), Sx(1,2), Sy(1,2), Sx(2,1), Sy(2,1), Sx(2,2), and Sy(2,2) of lens stacks 13(1,1), 13(1,2), 13(2,1) and 13(2,2) of lens array 13 respectively (see FIG. 4) may be configured such that image pixels in single-color, spatially offset images captured by image sensors such as image sensors 16(1,1), 16(1,2), 16(2,1) and 16(2,2) may each correspond to a single one of the pixels in the grid of pixels in the super-resolution color image.

Various embodiments have been described illustrating electronic devices having array cameras that include arrays of image sensors, arrays of associated lenses and array of associated color filters in which lenses are aligned with positions on associated image sensors other than the centers of the associated image sensors. An array of lenses may include one or more layers of lenses formed by compression molding of transparent materials such as plastic. Multiple layers of lenses in an array of lenses may be combined to form a lens stack associated with each image sensor in an array of image sensors. Image sensors may be formed on a single integrated circuit die. Arrays of lenses may be mounted directly onto the integrated circuit die on which the array of image sensors is formed. Each lens stack may have an associated color filter that filters incoming light before the light passes through the lens stack. Each image sensor may include a second color filter formed on the integrated circuit die that further filters the incoming light after it has passed through the lens stack and before it reaches photosensitive components of image pixels in the image sensor. Image sensors may further include microlenses formed on each image pixel for focusing incoming light onto the image pixel. Color filter arrays may include one or more red filters, one or more green filters and one or more blue filters. Lens stacks that focus light onto associated image sensors of an image sensor array may have centers that are offset from the center of the associated image sensor. Offsetting the centers of lens stacks with respect to the centers of associated image sensors may allow capture of spatially offset single-color images by the image sensors. Spatially offset single-color images may be combined into super-resolution images using the processing circuitry.

The foregoing is merely illustrative of the principles of this invention which can be practiced in other embodiments.

What is claimed is:

1. A camera module, comprising:
an array of lenses each having a center;
an array of color filters; and
an array of images sensors each of which receives image light from a corresponding one of the lenses through a corresponding one of the color filters, wherein each image sensor has a center and a plurality of image pixels having a common maximum lateral image pixel dimension, wherein the center of at least one of the lenses in the array of lenses is laterally offset from the center of the corresponding image sensor that receives the image light from that lens, wherein the lateral offset of the at least one of the lenses has a magnitude and a direction, and wherein the magnitude of the lateral offset is smaller than the common maximum lateral image pixel dimension.

2. The camera module defined in claim 1 wherein the magnitude of the lateral offset is larger than one eighth of the common maximum lateral image pixel dimension.

3. The camera module defined in claim 2 wherein the center of at least an additional one of the lenses in the array of lenses is laterally offset from the center of the corresponding image sensor that receives the image light from that additional one of the lenses in a direction that is different from the direction of the lateral offset of at the least one of the lenses.

4. The camera module defined in claim 3 further comprising a cover layer mounted on the array of color filters.

5. The camera module defined in claim 4 wherein the array of lenses comprises first, second, and third layers of lenses, wherein each image sensor of the array of image sensors receives the image light from a corresponding one of the lenses of the first layer of lenses through a corresponding one of the lenses of the second layer of lenses and through a corresponding one of lenses of the third layer of lenses.

6. The camera module defined in claim 5 wherein the first layer of lenses is formed from a first molded lens structure, wherein the second layer of lenses is formed from a second molded lens structure, and wherein the third layer of lenses is formed from a third molded lens structure.

7. The camera module defined in claim 6 wherein each image sensor in the array of image sensors comprises:
a plurality of microlenses that focus light onto the plurality of image pixels; and
a color filter interposed between the plurality of image pixels and the plurality of microlenses that passes a single color of light.

8. A camera module, comprising:
an array of image sensors formed on a common integrated circuit die; and
a first layer of lenses mounted to the common integrated circuit die using a plurality of housing structures and a spacer-buffer structure, wherein the spacer-buffer structure separates the image sensors of the array of image sensors from each other.

9. The camera module defined in claim 8, further comprising a second layer of lenses mounted on the first layer of lenses using the plurality of housing structures and at least one spacer structure.

10. The camera module defined in claim 9, further comprising a third layer of lenses mounted on the second layer of lenses using the plurality of housing structures and at least one additional spacer structure.

11. The camera module defined in claim 10 further comprising:
a cover layer mounted on the third layer of lenses using the plurality of housing structures; and
an array of color filters interposed between the cover layer and the third layer of lenses, wherein each of the image sensors receives image light from a corresponding one of the lenses in each of the first, second, and third layers of lenses, through a corresponding one of the color filters.

12. The camera module defined in claim 11 wherein the first, second, and third layers of lenses comprise first, second, and third molded lens structures respectively.

13. The camera module defined in claim 12 wherein the first, second, and third molded lens structures are formed from the same material.

14. The camera module defined in claim 13 wherein the second layer of lenses has opposing top and bottom sides, wherein the first layer of lenses is mounted on the bottom side and wherein the bottom side of the second layer of lenses is substantially planar.

15. The camera module defined in claim 14 wherein each lens of the first layer of lenses has a center, wherein each of the image sensors has a center, and wherein the center of at least one of the lenses of the first layer of lenses is laterally offset from the center of the corresponding image sensor that receives image light from that lens.

16. The camera module defined in claim 15 wherein each lens in the second layer of lenses is substantially aligned with a corresponding one of the lenses in the first layer of lenses and with a corresponding one of the lenses in the third layer of lenses.

17. A method for capturing super-resolution images with an electronic device having processing circuitry and a camera module with an array of image sensors each of which has a corresponding offset lens stack and a corresponding color filter comprising:
with each image sensor, capturing a single-color, spatially-offset image having a common pixel size; and
with the processing circuitry, combining the single-color, spatially-offset images to form a super-resolution image having a pixel size that is smaller than the common pixel size of the single-color, spatially-offset images.

18. The method defined in claim 17 wherein the array of image sensors comprises four image sensors, wherein the corresponding color filters include a red color filter, a blue color filter and two green color filters and wherein capturing the single-color, spatially-offset image with each image sensor comprises capturing a red image, a blue image, and first and second green images.

19. The method defined in claim 18 further comprising:
with the processing circuitry, generating a grid of pixels having pixel sizes that are smaller than the common pixel size of the single-color, spatially-offset images.

20. The method defined in claim 19 wherein the offset lens stacks are configured to spatially offset the single-color, spatially-offset images and wherein combining the single-color, spatially-offset images to form a super-resolution image comprises:
with the processing circuitry, assigning each pixel in the grid of pixels a value corresponding to an associated value of an overlapping pixel in a selected one of the single-color, spatially-offset images.
